(19) United States
(12) Patent Application Publication
(10) Pub. No.: US 2017/0268221 A1
(43) Pub. Date: Sep. 21, 2017

(54) MOLDED HEAT INSULATION MEMBER COMPRISING CAPILLARY-ACTIVE ELEMENTS

(71) Applicants: Matthias GEISLER, Grosskrotzenburg (DE); Gabriele GAERTNER, Hanau (DE)

(72) Inventors: Matthias GEISLER, Grosskrotzenburg (DE); Gabriele GAERTNER, Hanau (DE)

(73) Assignee: Evonik Degussa GmbH, Essen (DE)

(21) Appl. No.: 15/531,478

(22) PCT Filed: Jan. 11, 2016
(86) PCT No.: PCT/EP2016/050329

§ 371 Date: May 30, 2017

(30) Foreign Application Priority Data
Jan. 16, 2015 (EP) 15151456.9

(51) Int. Cl. E04B 1/80; B32B 5/02; B32B 5/18; E04B 1/76

(52) U.S. Cl. CPC E04B 1/80; E04B 1/762; B32B 5/02; B32B 5/18; B32B 2307/304; B32B 2419/00

(57) ABSTRACT

Thermal insulation body comprising a thermally insulating core having holes filled with a capillary-active material, wherein the thermally insulating core is capillary-inactive and the capillary-active material in the holes comprises capillary-active wicks.

The invention relates to a thermal insulation body comprising a thermal insulation board having holes filled with a capillary-active material.

Internal insulation, by virtue of capillary-active regions open to water vapour diffusion, is supposed to permit absorption of room air humidity into the wall on the one hand, and assure recycling of liquid water, condensate, into the room through capillary action and vaporization on the other hand.

It is known from half-timbered building design, for example, that moisture can be led off between the outer wall and inner wall. DE 202005005231 discloses production of half-timbered constructions in which bricks are arranged between the wooden bars that are typical of a timber-framed exterior wall. Provided on the interior side is a render composed of straw and clay, with capillary-conductive insulation boards placed in front. The insulation boards and clay layer are connected by a capillary-conductive element. A disadvantage here is the high thermal conductivity of the capillary-conductive insulation boards.

WO2009/026910 claims an interior insulation having an insulating layer on the inside with capillary-conductive regions which run from one side of the insulation layer right through to the other side of the insulation layer. An example of a useful insulating layer is a polyurethane foam board provided with holes filled with a mineral mortar. A disadvantage is that, as a result of the filled holes, the elasticity of the board is lost and it is damaged when bent, and the filling may even fall out completely. Even when cutting to size on site, the capillary-active component may have to be discarded, which can give rise to pockets of moisture in the brickwork.

WO2014/044709 discloses a wall construction for an interior insulation system comprising thermal insulation boards, wherein the boards comprise, for example, hydrophobized silica as the main constituent and are fixed on site to an existing or new capillary-active layer with a defined gap width on the wall side. These gaps are filled with a capillary-active layer, and the side of the thermal insulation boards facing the interior of the room is also covered with a capillary-active layer, meaning that the thermal insulation boards are surrounded by these capillary-active layers on all sides. The gaps are filled up with the aid of capillary-active, preferably thermally insulating, gap fillers, mortars or renders. On the room side, the thermal insulation boards are likewise covered with a capillary-active, preferably thermally insulating, layer, such that the thermal insulation boards are surrounded by the layers described above on all sides. The capillarity is determined by the choice of gap width, in combination with the gap mortar. It has been found that the capillary-active gaps have to be relatively broad for sufficient outward transport of water. Since the gap material has a higher thermal conductivity than the thermal insulation board, the thermal conductivity of the composite as a whole is increased.

The problem addressed was therefore that of providing insulation suitable both for internal insulation and, in areas with high air humidity and high temperature, for example in the tropical climate zone, for external insulation, having high thermal insulation combined with high mechanical strength.

The object is achieved by providing a hydrophobic material with capillary activity.

The invention provides a thermal insulation body comprising a thermally insulating core having holes filled with a capillary-active material, wherein the thermally insulating core is capillary-inactive and the capillary-active material in the holes comprises or consists of capillary-active wicks.

The thermal insulation body of the invention or the thermally insulating core should not involve vacuum insulation. The thermal insulation body of the invention preferably meets the requirements of the A1 and A2 construction material class according to DIN EN ISO 13501-1.

Capillary wicks shall be understood to mean that the individual elements of the wicks have a diameter of 4 to 100 μm, preferably 10 to 50 μm. The material of the individual elements should be chosen such that the diameter, according to the equation for capillary rise height h

h=(2σ cos θ)/(ρgr),

with σ=surface tension, θ=contact angle, ρ=density of the liquid,

g=acceleration due to gravity and r=radius,

leads to a theoretical rise height of the liquid column of about 3 m to 14 cm.

The capillary-inactive thermally insulating core has a coefficient of water absorption of less than 0.5 kg/m²h^{0.5}. The water absorption coefficient is determined to EN ISO 15148.

The holes should preferably be kept small in order not to significantly increase the thermal conductivity of the thermally insulating core. In general, the diameter of the holes is 100 to 6000 μm, more preferably 500 to 3000 μm.

The capillary-active wicks have a density per unit area of preferably 10 to 10 000 wicks/m², more preferably 25 to 2000 wicks/m². The cross-sectional area of a capillary-active wick is preferably 0.001 to 1 mm², more preferably 0.005 to 0.4 mm². The capillary-active wicks should have maximum tensile strength. This can be varied via the number, diameters or density per unit area.

The capillary-active wicks need not encompass the hole completely. The capillary-active wicks are not mortars that fill the full hole area, as known from the prior art.

The capillary-active wicks may be yarns, twines, threads, textured spun threads, filaments and cords. Yarn is understood to mean a thin structure composed of one or more fibres. Fibres of very high, virtually unlimited length are called filaments. A twine is a linear structure consisting of a plurality of entwined yarns. A twine has a significantly higher tear strength than the non-entwined simple yarns. A thread is a structure composed of several bonded or twisted fibres. It is long, thin and flexible. It can be woven, knitted, tufted or processed in other ways. A thick thread is more likely to be termed a cord. Preferably, the capillary-active wicks of the invention are threads.

The material of the capillary-active wicks may consist of an inorganic or organic material. Preference is given to all inorganic types which have a hydrophilic size or are unsized. But it is also possible to use organic capillary-active wicks. This limits the later maximum use temperature before structural degradation sets in. In addition, the combustible fraction of the thermal insulation body is increased. Inventive thermal insulation bodies containing capillary-active wicks composed of an organic material should meet the requirements of the A1 and A2 construction material classes (to DIN EN ISO 13501-1).

More preferably, the material is selected from the group consisting of basalt, silica, E glass, C glass and glass.

To increase mouldability and tensile strength, it is also possible that the capillary-active wicks are present as a mixture of glass fibres and individual filaments of a thermoplastic or of glass fibres and metal strands. Particular preference is given to the inorganic capillary-active wicks which can be assigned to the “non-combustible” material class according to DIN EN ISO 13501-1.

The capillary-active wicks may project out of the thermal insulation body and optionally additionally be fanned out, or end flush with the surface of the thermal insulation body.

The thermally insulating core may be a thermal insulation board, a thermal insulation mat or a thermal insulation bed. The thermal insulation board is defined as a relatively flat, substantially and even and solid article having an equal thickness nearly throughout. By comparison, a thermal insulation mat is less solid and flexible. A thermal insulation bed is not dimensionally stable in the event of movement. Particular preference is given to a thermal insulation board.

The thickness of the thermally insulating, capillary-inactive core is generally 3 mm to 150 mm. Preference is given to a range from 10 to 50 mm for a thermal insulation board or a thermal insulation mat and a range from 5 to 50 mm for a thermal insulation bed.

The capillary-inactive, thermally insulating core is hydrophobic. It preferably has a thermal conductivity of less than 0.025 W/(mK), more preferably 0.010 to 0.020 W/(mK). Thermal conductivity was determined to DIN EN 12667.

The core further preferably has vapour diffusion-inhibiting properties or is open to vapour diffusion. According to DIN 4108-3, a system is defined as being open to diffusion if s_{D}≧0.5 m, and as diffusion-inhibiting if 0.5 m<s_{D}<1500 m. The s_{D} value is the product of the thickness of the layer and the water vapour diffusion resistance coefficient.

Possible constituents of the capillary-inactive, thermally insulating core include hydrophobic silica, hydrophobic aerogels that are organic or inorganic in nature, polyurethanes and polystyrene.

A preferred constituent of the capillary-inactive, thermally insulating core is hydrophobic silica. Particularly advantageous in this context is fumed hydrophobic silica. In general, this silica is part of a thermal insulation mixture which may additionally contain IR opacifiers, for example titanium oxides, zirconium oxides, ilmenite, iron titanate, iron oxides, zirconium silicate, silicon carbide, manganese oxide and carbon black, optionally in fibrous form.

The hydrophobic fumed silica is generally obtained by flame hydrolysis and then hydrophobized. In flame hydrolysis, a vaporized or gaseous hydrolysable silicon halide is reacted with a flame formed by combustion of hydrogen and of an oxygen-containing gas. The combustion flame here provides water for the hydrolysis of the silicon halide, and sufficient heat for the hydrolysis reaction. A silicon dioxide produced in this way is referred to as fumed silica. It takes the form of aggregates which, because of their three-dimensional, open structure, are microporous and macroporous. By virtue of this structure, fumed silicon dioxide powders are ideal insulating materials, since the aggregate structure imparts sufficient mechanical stability, transmission of heat through solid-state conductivity is minimized through the very small contact sites within an aggregate, and sufficiently high porosity is generated.

The best results in terms of thermal insulation are obtained when the thermally insulating core comprises hydrophobized fumed silica.

If the thermally insulating, capillary-inactive core is a thermal insulation board containing hydrophobic fumed silica, it is advantageous, as described in WO 2013/013714, first to produce the hydrophilic board and then to hydrophobize it under reduced pressure or elevated pressure. Hydrophobization is preferably accomplished using organosilanes which react with the silanol groups of the hydrophilic constituents of the thermal insulation mixture. Useful organosilanes include Rₙ—Si—X₄₋ₙ, R₃Si—Y—SiR₃, RₙSiₙOₙ, (CH₃)₃—Si—(O—Si(CH₃)₂)ₙ—OH, HO—Si(CH₃)₂—(O—Si(CH₃)₂)ₙ—OH, with n=1-8; R=—H, —CH₃, —C₂H₅; X=—Cl, —Br; —OCH₃, —OC₂H₅, —OC₃H₈, Y=NH, O. The following should be mentioned explicitly: (CH₃)₃SiCl, (CH₃)₂SiCl₂, CH₃SiCl₃, (CH₃)₃SiOC₂H₅, (CH₃)₂Si(OC₂H₅)₂, CH₃Si(OC₂H₅)₃, (CH₃)₃SiNHSi(CH₃)₃, (CH₃)₃SiOSi(CH₃)₃, (CH₃)₈Si₄O₄ [octamethyltetracyclosiloxane], (CH₃)₆Si₃O₃ [hexamethyltricyclosiloxane] and (CH₃)₃Si(OSi(CH₃)₂)₄OH [low molecular weight polysiloxanol].

In a particular embodiment of the invention, the thermal insulation body comprises at least one capillary-active outer layer on one or both sides of the thermally insulating, capillary-inactive core, with the capillary-active wicks ending within or protruding from the capillary-active outer layer.

The material of the capillary-active outer layer is preferably selected from the group consisting of a capillary-active textile fabric, for example a woven, nonwoven or knitted fabric, a capillary-active open-pore foam, the latter having been applied as a finished layer or being foamed directly on the surface, and/or a capillary-active porous layer which is applied, for example, by spray/dip/nozzle coating or bar coating.

A further embodiment of the invention has a layer that acts as a vapour barrier or vapour retarder between the thermally insulating, capillary-inactive core and the capillary-active outer layer, through which the capillary-active wicks are conducted. Suitable materials for a vapour barrier or a vapour retarder are, for example, glass, polyethylene or metals such as aluminium.

FIG. 1 shows the regular penetration of capillary-active wicks into a thermal insulation board laminated all-round with a capillary-active material. The resultant inventive thermal insulation body has elevated tensile strength and low thermal conductivity. A=regular penetration of capillary-active wicks; B=all-round lamination with capillary-active material, for example fabric or combination with mortar.

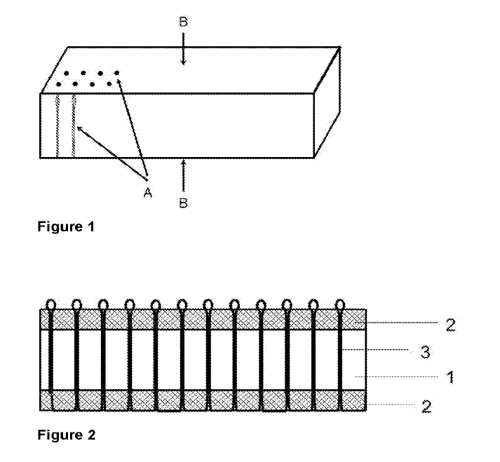

FIG. 2 shows a thermal insulation body produced by tufting,

wherein the thermally insulating, capillary-inactive core is a thermal insulation board (1) containing hydrophobized silica and an IR opacifier,
wherein the capillary-active outer layer consists of mineral wool (2) and
wherein the capillary-active wicks comprise glass fibres (3).
The final mechanical strength can be increased by bonding to the wall, in that the lugs are joined flat to one another or are bonded at least locally.

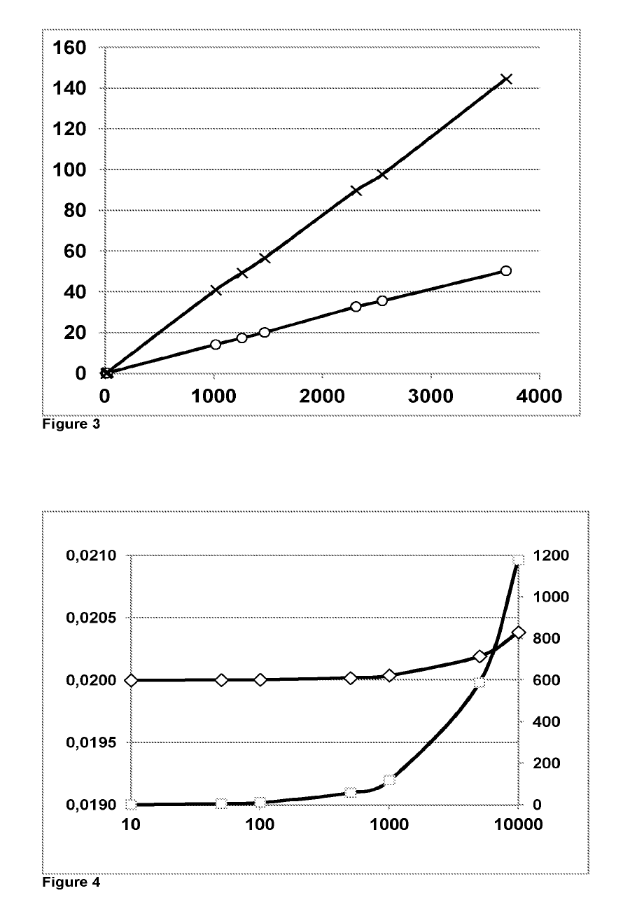

FIG. 3 shows the effect of the capillary-active wicks. For this purpose, the thermal insulation body is introduced into a water-filled tank. The thermal insulation body floats with a small gap from the edge of the tank in order to minimize free convection/evaporation and to always assure good contact with the water. The arrangement is on a balance. Under defined flow conditions in a fume hood at 22° C., the decrease in mass with time is measured simultaneously. The thermal insulation body is

a) a hydrophobic board (200×200×35 mm) which is open to diffusion, the main constituent of which is a hydrophobized fumed silica (CALOSTAT®, Evonik Industries). The water vapour has to diffuse through the board before there is free convection above it. In FIG. 3, the values are marked with o.

b) a CALOSTAT® board with 3 capillary-active wicks and with a capillary-active topsheet (170×200 mm). Each wick consists of about 7000 individual glass fibres having a diameter of about 10 μm. In FIG. 3, the values are marked with x. Here, the water is conveyed into the outer layer through the wicks, where there is evaporation with free or forced convection because of the fume hood. The evaporation rate is about three times higher with wicks than without capillary-active wicks. The 3 capillary-active wicks are already completely sufficient to permanently wet the topsheet. In FIG. 3, the amount of water evaporated in grams is plotted against time in minutes.

FIG. 4 shows a calculated thermal conductivity and tensile strength of a stepped thermal insulation body comprising a capillary-inactive thermal insulation board open to diffusion, CALOSTAT®, and a capillary-active top layer and capillary-active wicks. For the tensile strength, the assumption is made that all capillary-active wicks hold up to the tear limit and there are no defects, the capillary-active wicks are made from glass fibres (tensile strength 3000 MPa) and the tensile strength of CALOSTAT® is 0 kPa. In addition, the capillary-active outer layers are assumed, in a simplification, to have the thickness d=0. In FIG. 4, the x axis represents the number of threads (diameter of the individual thread=10 μm) per wick, the left-hand y axis represents lambda in W/(mK) (marker in FIG. 4: rhombus), and the right-hand y axis represents the tensile strength in kPa (marker in FIG. 4: square).

Starting from 20 mW/(mK) for the capillary-inactive, thermally insulating core, the thermal conductivity increases with increasing number of capillary-active wicks. The capillary-active wicks are stepped here in a pattern of 4×5 cm². The number of individual threads per wick is varied. Not until 10 000 threads per wick does the thermal conductivity rise by nearly 0.5 mW/(mK). This corresponds to an effective wick cross section of 0.8 mm. The pattern chosen results in 500 wicks per square metre. Thus, while thermal insulation decreases only slightly, tensile strength increases distinctly.

A real measurement for a stepped thermal insulation body made from a CALOSTAT® board having a thickness of 30 mm, capillary-active wicks as specified in the description for FIG. 3, and with 12 mm of mineral wool, Akustic EP3 ISOVER St. GOBAIN, as outer layer on both sides, gives an effective thermal conductivity of 0.024 W/(mK). The measurement was conducted with a board device at bulk temperature 10° C. with a contact pressure of 2000 Pa. The theoretical value is 0.025 W/(mK). This shows good agreement of theory and practice.

1-14. (canceled)

15. A thermal insulation body, comprising:
a thermally insulating core having holes filled with a capillary-active material,
wherein the thermally insulating core is capillary-inactive and the capillary-active material in the holes comprises capillary-active wicks.

16. The thermal insulation body according to claim 15,
wherein the holes have a diameter of 100 to 6000 μm.

17. The thermal insulation body according to claim 15,
wherein the capillary-active wicks have a density per unit area of 10 to 10 000 wicks/m².

18. The thermal insulation body according to claim 15,
wherein the cross-sectional area of the capillary-active wicks is from 0.001 to 1 mm².

19. The thermal insulation body according to claim 15,
wherein the capillary-active wicks comprise a material selected from the group consisting of yarns, twines, threads, textured spun threads, filaments and cords.

20. The thermal insulation body according to claim 15,
wherein the material of the capillary-active wicks is selected from the group consisting of basalt, silica, E glass, C glass and glass.

21. The thermal insulation body according to claim 15,
wherein the capillary-active wicks project out of the thermal insulation body or end flush with the surface of the thermal insulation body.

22. The thermal insulation body according to claim 15,
wherein the thermally insulating, capillary-inactive core is a thermal insulation sheet, a thermal insulation mat or a thermal insulation bed.

23. The thermal insulation body according to claim 15,
wherein the thickness of the thermally insulating, capillary-inactive core is 3 to 150 mm.

24. The thermal insulation body according to claim 15,
wherein the thermally insulating, capillary-inactive core has a thermal conductivity of less than 0.025 W/(mK).

25. The thermal insulation body according to claim 15,
wherein the thermally insulating, capillary-inactive core contains hydrophobic fumed silica.

26. The thermal insulation body according to claim 15,
which comprises at least one capillary-active outer layer on one or both sides of the thermally insulating, capillary-inactive core, with the capillary-active wicks ending within or protruding from the capillary-active outer layer.

27. The thermal insulation body according to claim 15,
wherein the material of the capillary-active outer layer is selected from the group consisting of a capillary-active textile fabric, a capillary-active open-pore foam and/or a capillary-active porous layer.

28. The thermal insulation body according to claim 15,
which has a layer that acts as a vapor barrier or vapor retarder between the thermally insulating, capillary-inactive core and the capillary-active outer layer, through which the capillary-active wicks are conducted.
